(19) United States
(12) Patent Application Publication
(10) Pub. No.: US 2009/0278321 A1
(43) Pub. Date: Nov. 12, 2009

(54) INTERNAL PIPE SEAL

(75) Inventor: James W. Skinner, Fort Wayne, IN (US)

Correspondence Address: BAKER & DANIELS LLP;111 E. WAYNE STREET, SUITE 800, FORT WAYNE, IN, 46802, US

(73) Assignee: PRESS-SEAL GASKET CORPORATION, Fort Wayne, IN (US)

(21) Appl. No.: 12/409,656

(22) Filed: Mar. 24, 2009

Related U.S. Application Data
(63) Continuation-in-part of application No. 12/187,473, filed on Aug. 7, 2008.
(60) Provisional application No. 60/955,517, filed on Aug. 13, 2007.

(51) Int. Cl. F16L 21/02; B23P 11/00

(52) U.S. Cl. 277/607; 29/428

(57) ABSTRACT

A pipe sealing assembly, and a method of installing the pipe sealing assembly, for sealing a connection between a pair of underground pipes, including a generally cylindrical seal or gasket having at least three axially spaced sealing portions. Each sealing portion has a plurality of compressible sealing ridges, as well as an annular expansion band seat capable of receiving the expansion band of an expansion band assembly that is used to sealingly compress each sealing portion against a respective inner surface of a pipe. The sealing portions may include a middle sealing portion that may directly sealingly engage about, and bridge, a joint between two pipes, or may directly sealingly engage about, and bridge, a crack in a pipe. Additionally, each sealing portion may include a hollow section which houses the expansion band assembly, and may be provided with a small slit for installing the expansion band assembly. The expansion band assembly includes one or more expansion bands and one or more expansion mechanisms. The expansion bands may be initially installed as part of the pipe sealing assembly, while the expansion mechanisms may be installed after the pipe sealing assembly is brought underground through a structure, such as a manhole, and positioned at an installation site.

### CROSS-REFERENCE TO RELATED APPLICATIONS

This application is a continuation-in-part of U.S. Utility patent application Ser. No. 12/187,473, entitled INTERNAL PIPE SEAL, filed on Aug. 7, 2008, which claims the benefit under Title 35, U.S.C. § 119(e) of U.S. Provisional Patent Application Ser. No. 60/955,517, entitled INTERNAL PIPE SEAL, filed on Aug. 13, 2007, each of the disclosures of which are expressly incorporated by reference herein in their entirety.

### BACKGROUND OF THE INVENTION

1. Field of the Invention

The present invention relates to an internal sealing assembly for sealingly connecting a pair of pipes and, in one embodiment, relates to a secondary sealing assembly that can be installed within an existing pipeline about an existing pipe-to-pipe connection to seal a leak.

2. Description of the Related Art

Underground pipes which are used in municipal water and sewer systems, for example, typically include bell and spigot ends that are attached to one another in a sealed manner. Typically, either the spigot end or the bell end of such pipes includes a rubber seal which is compressed between the ends of the pipes to provide a sealed joint when the spigot end of one pipe is inserted into the bell end of another pipe. Occasionally, these primary joint seals between adjacent pipes may leak after installation in the field, requiring a secondary sealing assembly to seal the connection.

What is needed is an improved sealing assembly for sealing pipe-to-pipe joints.

### SUMMARY OF THE INVENTION

The present invention provides a pipe sealing assembly for sealing a connection between a pair of pipes. The sealing assembly includes a generally cylindrical seal or gasket having a pair of axially spaced sealing portions joined by a bridge portion. Each sealing portion has a plurality of compressible sealing ridges, as well as an annular expansion band seat capable of receiving the expansion band of an expansion band assembly that is used to sealingly compress each sealing portion against a respective inner surface of a pipe. Additionally, each sealing portion may include a hollow section which houses the expansion band assembly, and may be provided with a small slit for installing the expansion band assembly and allowing access to the expansion mechanism of the expansion band assembly during installation, or a separate cover member for enclosing the expansion band assembly.

The present invention also provides a pipe sealing assembly, and a method of installing the pipe sealing assembly, for sealing a connection between a pair of underground pipes, including a generally cylindrical seal or gasket having at least three axially spaced sealing portions. Each sealing portion has a plurality of compressible sealing ridges, as well as an annular expansion band seat capable of receiving the expansion band of an expansion band assembly that is used to sealingly compress each sealing portion against a respective inner surface of a pipe. The sealing portions may include a middle sealing portion that may directly sealingly engage about, and bridge, a joint between two pipes, or may directly sealingly engage about, and bridge, a crack in a pipe. Additionally, each sealing portion may include a hollow section which houses the expansion band assembly, and may be provided with a small slit for installing the expansion band assembly. The expansion band assembly includes one or more expansion bands and one or more expansion mechanisms. The expansion bands may be initially installed as part of the pipe sealing assembly, while the expansion mechanisms may be installed after the pipe sealing assembly is brought underground through a structure, such as a manhole, and positioned at an installation site.

In one form thereof, the present invention provides a sealing assembly, including a cylindrical seal, including a pair of axially-spaced, annular sealing portions, each sealing portion including an expansion band seat and a wall section defining an annular hollow space proximate the expansion band seat; and a bridge portion joining the sealing portions; and a pair of expansion band assemblies respectively received within the hollow spaces, each expansion band assembly including an expansion band, the expansion bands respectively received within the expansion band seats; and an expansion mechanism.

In another form thereof, the present invention provides a sealing assembly, including a cylindrical seal, including a pair of axially-spaced, annular sealing portions, each sealing portion including an expansion band seat and a separate cover member attachable to the sealing portion to define an annular hollow space proximate the expansion band seat; and a bridge portion joining the sealing portions; and a pair of expansion band assemblies respectively received within the hollow spaces, each expansion band assembly including an expansion band, the expansion bands respectively received within the expansion band seats; and an expansion mechanism.

In another form thereof, the present invention provides a sealing assembly, including a cylindrical seal, including at least three axially-spaced annular sealing portions, each sealing portion including an expansion band seat; and a plurality of expansion band assemblies, each expansion band assembly including an expansion band received within a respective expansion band seat; the expansion band including a pair of end portions; and an expansion mechanism, each expansion mechanism including a drive mechanism, including a pair of block members each having a threaded bore therethrough, the block members removably engaged with respective end portions of the expansion band; and a bolt including oppositely-threaded ends respectively threaded within the bores of the block members, wherein rotation of the bolt in a first direction causes the block members to be simultaneously driven apart from one another to thereby expand the expansion band.

In another form thereof, the present invention provides a method for installing a sealing assembly, the method including the steps of: providing a sealing assembly, including a cylindrical seal having a first diameter, comprising at least one annular sealing portion, each sealing portion including an expansion band seat; and at least a pair of expansion band segments each received within the expansion band seat, the expansion band segments each having a pair of end portions that respectively define a pair of gap portions between respective end portions of the expansion band segments; folding the sealing assembly about the gap portions to a width less than the first diameter; passing the sealing assembly into an underground structure having an opening with a second diameter, the second diameter being greater than the width and less than the first diameter; and installing the sealing assembly.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a sealing assembly according to one embodiment of the present invention, shown sealing a connection between a pair of pipes;

FIGS. 2A-D are sectional views through four different embodiments of sealing assemblies according to the present invention;

FIG. 3 is a partial sectional view through a pipe joint, showing the sealing assembly of FIG. 2A installed therein;

FIGS. 4A-C are sectional views through three further embodiments of sealing assemblies according to the present invention;

FIG. 5 is a perspective view of a sealing assembly according to another embodiment of the present invention, shown sealing a connection between a pair of pipes;

FIG. 6 is sectional view through the sealing assembly, taken along line 6-6 of FIG. 5;

FIG. 7 is a first schematic perspective view of the sealing assembly of FIGS. 5 and 6, showing a user gripping the sealing assembly prior to folding same;

FIG. 8 is a second schematic perspective view of the sealing assembly, showing the user folding the sealing assembly about gap portions between ends of the expansion bands of the sealing assembly;

FIG. 9 is a perspective and sectional view of the sealing assembly being brought into an underground pipeline;

FIG. 10 is sectional view through another embodiment of a sealing assembly according to the present invention;

FIG. 11 is a schematic, multi-fragmentary view of portions of a manhole riser including the sealing assembly of FIG. 2C shown installed in the upper left portion of the drawing, and the sealing assembly of FIG. 10 shown installed in the upper right portion of the drawing, each of the sealing assemblies sealing a connection between a manhole chimney and one or more grade rings; and

FIG. 12 is an enlarged, fragmentary view of an end sealing portion of the sealing assemblies of FIG. 11.

Corresponding reference characters indicate corresponding parts throughout the several views. The exemplifications set out herein illustrate embodiments of the invention, and such exemplifications are not to be construed as limiting the scope of the invention any manner.

### DESCRIPTION OF THE INVENTION

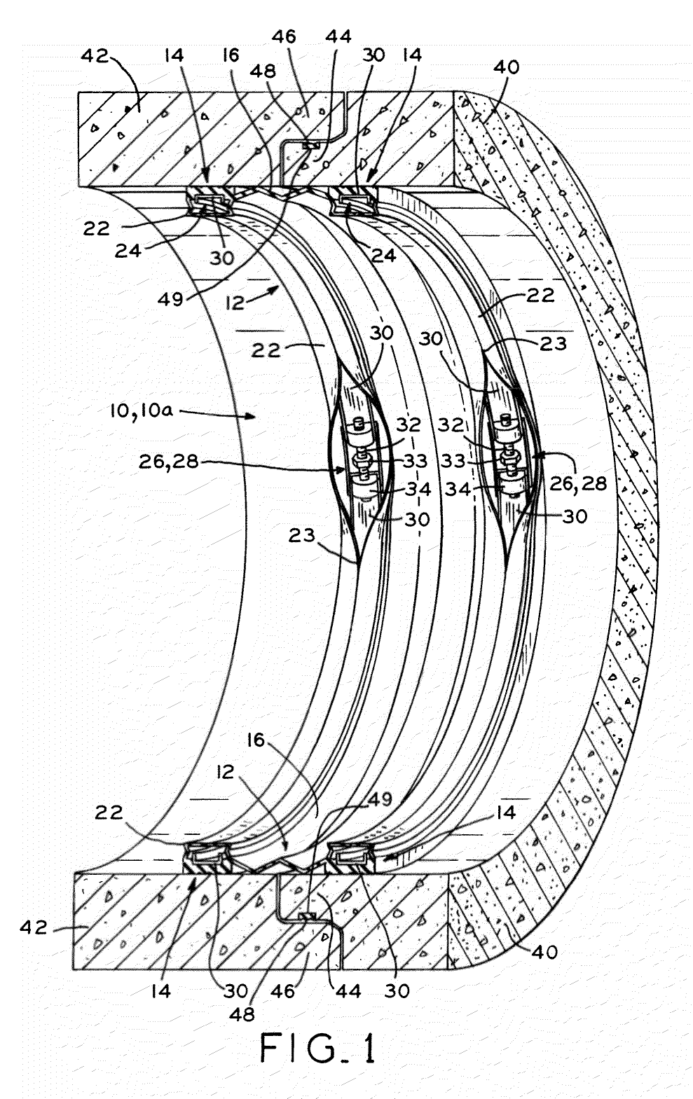

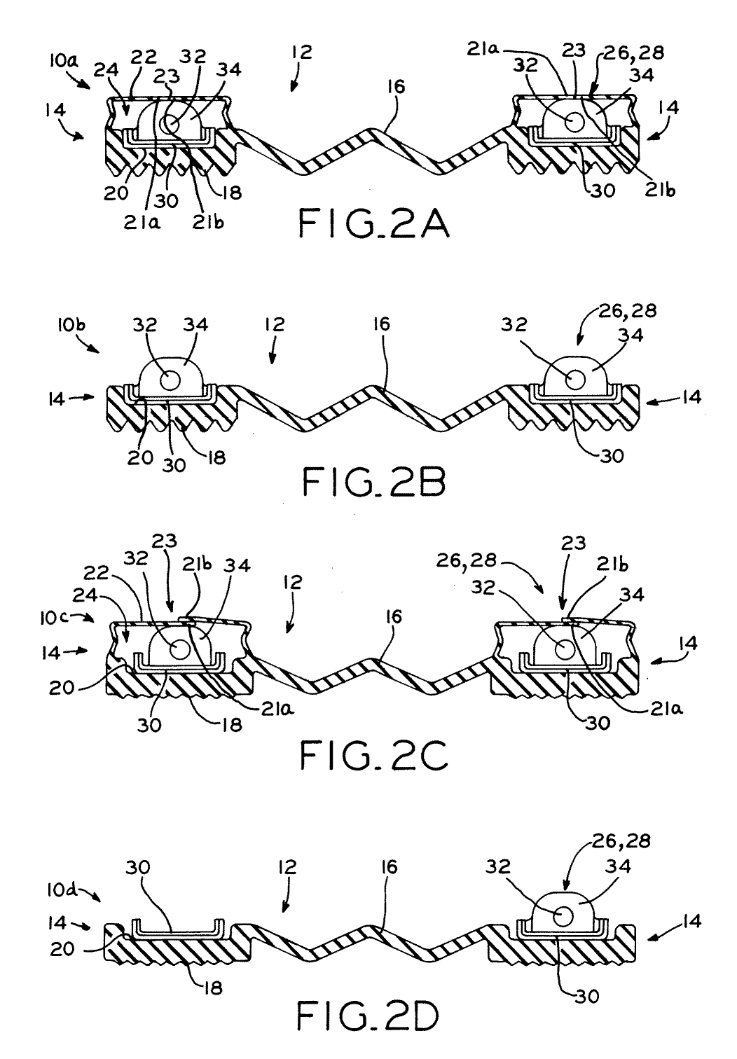

Referring to FIGS. 1 and 2A-D, four different embodiments of sealing assembly 10 of the present invention are shown. Except as discussed below, each sealing assembly 10a-10d includes a number of identical or substantially identical components, and identical reference numerals will be used throughout FIGS. 2A-D to designate identical or substantially identical components therebetween.

Each sealing assembly 10 includes a generally cylindrically shaped seal 12 having pair of axially spaced sealing portions 14 connected by a bridge portion 16. Bridge portion 16 may include one or more undulations as shown in order to permit movement of sealing portions 14 toward and away from one another along their common axis, i.e., a longitudinal axis passing through the center of seal 12. Seal 12 may be made of extruded rubber, for example, in a manner in which a length of rubber section is extruded, and then is cut to a predetermined length, followed by splicing the ends of the section together to form the cylindrical seal 12. Seal 12 may also be made of a resilient plastic material by an injection molding process, for example.

Each sealing portion 14 includes a plurality of sealing ridges 18 that are compressible against the internal surface of a pipe to provide a fluid tight seal. Additionally, each sealing portion 14 further includes an annular expansion band seat 20, shown herein as an annular recessed area of sealing portions 14, for receiving an expansion band of an expansion mechanism, as discussed below.

Additionally, as shown with respect to the embodiments of FIGS. 1, 2A and 2C, each sealing portion 14 may also be provided with a thin wall section 22 defining an annular hollow section 24 in the sealing portion 14 which accommodates the expansion band and the expansion mechanism of the expansion band assembly. As discussed below, the thin wall section 22 may include a small slit 23 for installation of the expansion band and expansion mechanism and for accessing the expansion mechanism during installation for sealingly compressing the sealing portion 12 into fluid tight engagement with the interior surface of the pipe.

Expansion band assembly 26 may be, for example, of the type disclosed in U.S. Pat. Nos. 6,805,359 and 7,146,689, each assigned to the assignee of the present invention, the disclosures of which are expressly incorporated herein by reference. Each expansion band assembly 26 generally includes an expansion mechanism 28 operable to expand the diameter of an expansion band 30 of the expansion band assembly 26 to radially outwardly to compress a sealing portion 14 against the inner surface of a pipe. In particular, as best shown in FIG. 1 and discussed in the above-incorporated U.S. Pat. Nos. 6,805,359 and 7,146,689, each expansion mechanism 28 generally includes a bolt 32 having oppositely-threaded ends and a central nut 33. The oppositely-threaded ends of bolt 32 are threadingly received within a pair of oppositely-threaded block members 34 which are in engagement with the opposite ends 30a and 30b of expansion band 30. In use, nut 33 of bolt 32 is engaged by a suitable tool to rotate bolt 32 and drive block members 34 apart from one another to thereby expand the diameter of expansion band 30 to radially outwardly compress a sealing portion 14 of seal 10 into tight engagement with the inner surface of a pipe.

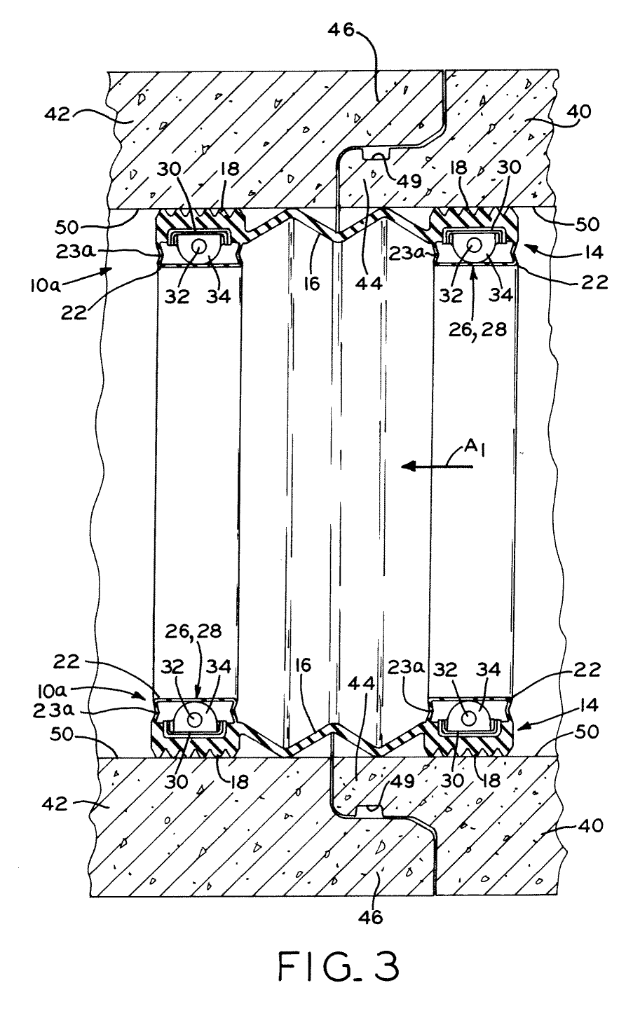

In use, referring additionally to FIG. 3 in which seal assembly 10a is shown as an example, seal assembly 10 may be used to seal a defective primary seal in a pipe-to-pipe connection between pipes 40 and 42, such as the connection between spigot end 44 of pipe 40 and socket end 46 of pipe 42 in which a primary seal 48 (FIG. 1), formed in an annular groove 49 of spigot end 44 of first pipe 40, is ineffective. Alternatively, seal assembly 10 may be used a primary seal to seal pipes 40 and 42 upon initial connection and installation of pipes 40 and 42, or may be used to seal across a crack in pipes 40 and/or 42.

Seal 12 is placed within the pipes 40 and 42 such that one sealing portion 14 is positioned adjacent spigot end 44 of pipe 40 and the other sealing portion 14 is positioned adjacent socket end 46 of pipe section 42, with bridge portion 16 of seal 12 bridging the gap between pipes 40 and 42. Thereafter, expansion mechanisms 28 of expansion band assemblies 26 are actuated in the manner described above to outwardly radially compress sealing portions 14 and their sealing ridges 18 of seal 12 into fluid tight sealing engagement with the inner surfaces 50 of pipes, respectively, thereby providing a fluid tight seal between pipes 40 and 42.

In the embodiments in which sealing portions 14 include thin wall sections 22, one or more slits 23 may be formed, or may be cut in the field, in wall sections 22 which allow for expansion bands 30 and expansion mechanisms 28 of expansion band assembly 26 to be slidably inserted within annular hollow sections 24. The slit 23 may be disposed adjacent an expansion mechanism 28 to allow access to expansion mechanism 28 during installation to effect the seal as described above. Each slit 23 may extend around only a portion of the circumference of its wall section 22, such as around as little as 5°, 10°, or 15°, or as great as 30°, 60°, 90° or more, for example, of the circumference of wall sections 22, or alternatively, may extend around the entire circumference of wall sections 22.

The adjacent portions 21a and 21b of thin wall sections 22 defined by slits 23 may be disposed in tight abutting end-to-end contact with one another, as shown in the embodiment of FIG. 2A, for example, or may overlap one another, as shown in the embodiment of FIG. 2C, for example, in order to minimize or prevent fluid entry into hollow sections 24. Further, as shown in FIG. 3, the slits 23 may be optionally disposed on a side of sealing portions 14 opposite a direction of fluid flow along arrow A₁, such as at location 23a, for example, to minimize or prevent fluid entry into hollow sections 24. Also, the expansion mechanisms 28 may be positioned at the upper end of the pipes 40 and 42 which are normally above the fluid level of the pipes to prevent or eliminate fluid entry into hollow sections 24.

Sealing assemblies 10 for small diameter pipes, such as up to 24 inches, may include one expansion mechanism 28, while sealing assemblies 10 for larger diameter pipes, such as greater than 24 inches, may include more than one expansion mechanism 28, as needed.

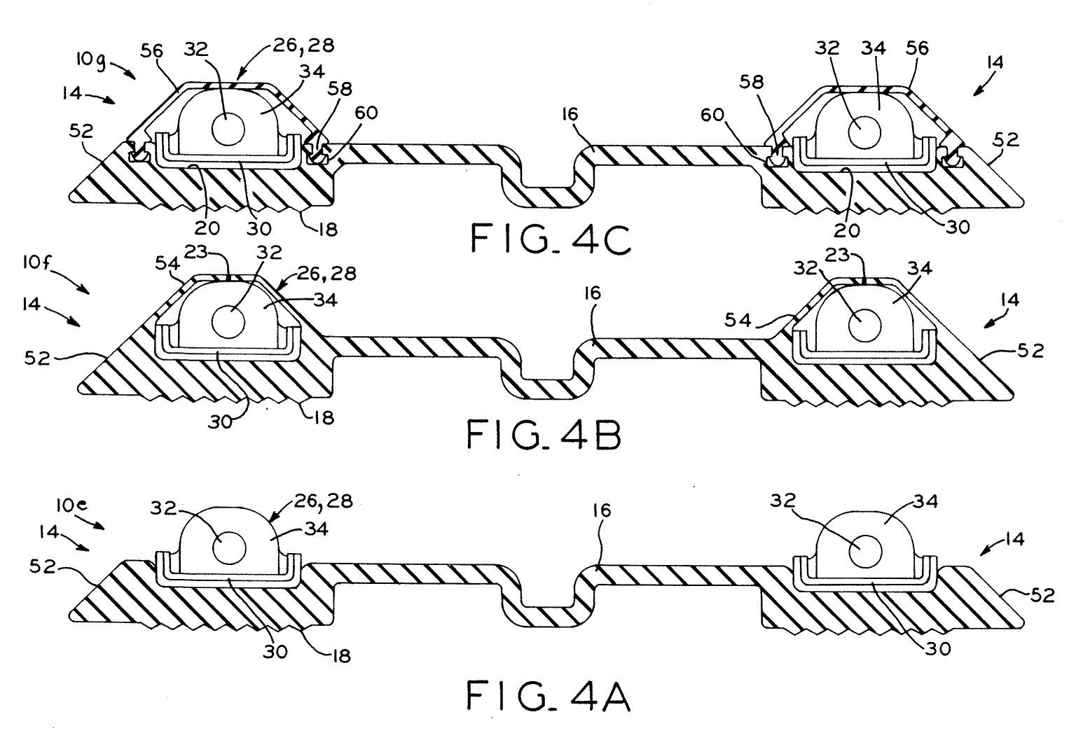

Referring to FIGS. 4A-C, sealing assemblies 10e-f according to further embodiments are shown, which, except as described above, are installed and function in the same manner as the embodiments discussed above, and identical reference numerals are used to identify identical or substantially identical components therebetween.

Sealing assembly 10e of FIG. 4A includes a ramp portion 52 at each of the ends of sealing portions 14 thereof to aid in directing a smooth or laminar flow of liquid within pipes 40 and 42 over and around the sealing assembly.

Sealing assembly 10f FIG. 4B includes ramp portions 52 at each of the ends of sealing portions 14 thereof similar to sealing assembly 10e of FIG. 4A, and also includes thin wall sections 54 similar to thin wall sections 22 of the embodiments discussed above, wherein thin wall sections 54 are also ramped complementary with ramp portions 52 to aid in directing the flow of liquid within pipes 40 and 42 over and around the sealing assembly.

Sealing assembly 10g of FIG. 4C includes a pair of separately extruded, or otherwise separately formed, annular cover members 56 each having a pair of barbed ends 58 for snap-fitting engagement with a pair of respective grooves 60 in sealing portions 14 of sealing assembly 10g that are disposed in either side of the expansion band seats 20. Cover members 56 are also ramped complementary with ramp portions 52 to aid in directing the flow of liquid within pipes 40 and 42 over and around the sealing assembly. In use, either before or after the seal 10 of sealing assembly 10g is extruded, the expansion bands 30 and expansion mechanisms 28 are assembled in place, and an amount of adhesive, such as a liquid solvent adhesive, is applied within grooves 60 in sealing portions 14. Thereafter, barbed ends 58 of cover members 56 are snap-fitted within grooves 60 to initially retain cover members 56 in place, covering expansion bands 30 and expansion mechanisms 28 until the adhesive cures to provide a more permanent connection of cover members 56 to sealing portions 14.

Cover members 56 may also include slits, such as slits 23 described above, adjacent expansion mechanisms 28 for allowing access to expansion mechanisms during installation. Alternatively, cover members 56 that lack such slits may be secured to seal 12 in the manner described above after expansion mechanisms 28 are actuated following installation to thereby seal expansion mechanisms 28 within sealing assembly 10g in a fluid tight manner.

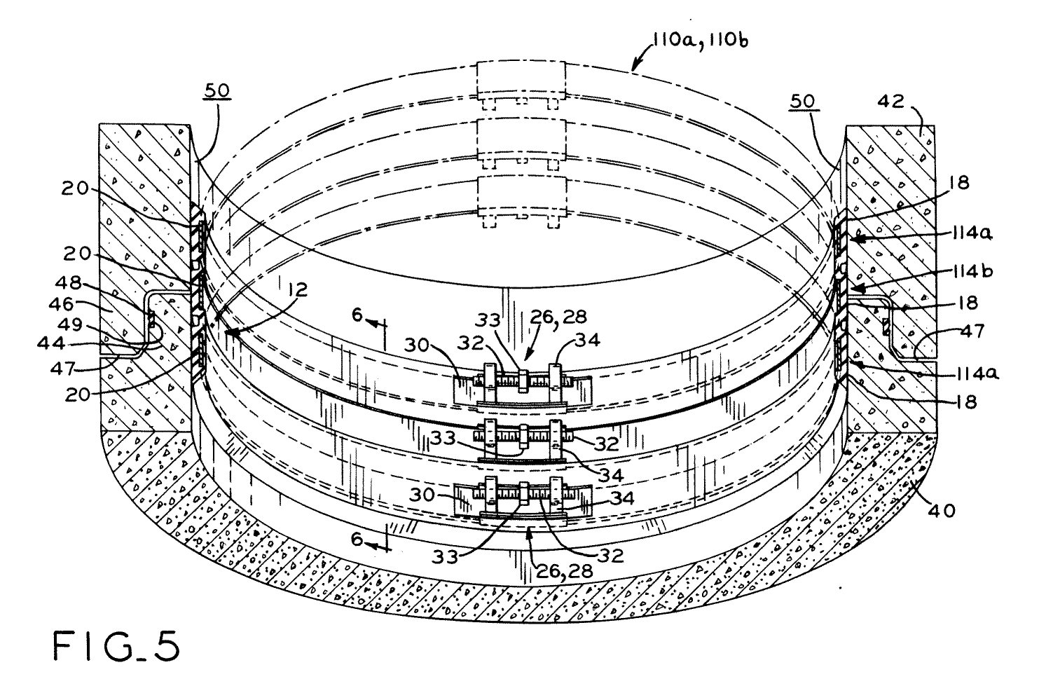

Referring to FIGS. 5-10, sealing assemblies 110a and 110b according to further embodiments are shown which, except as described below, are installed and function in the same manner as the embodiments discussed above, and identical reference numerals are used to identify identical or substantially identical components therebetween.

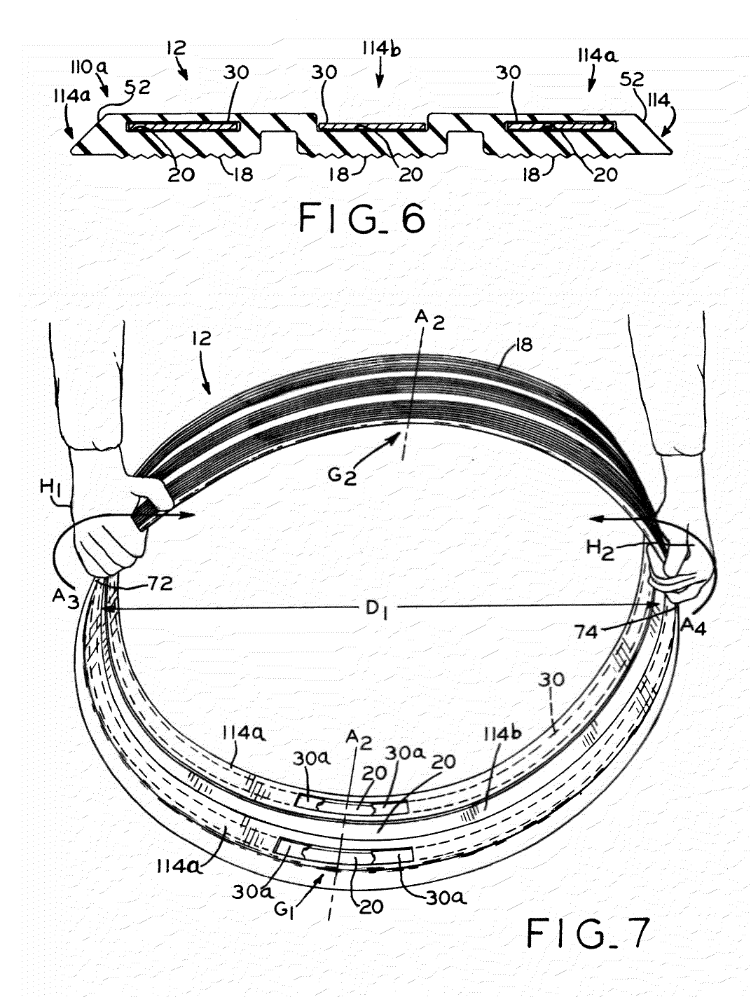

Referring now to FIGS. 5 and 6, sealing assembly 110 includes a generally cylindrically shaped seal 112 having at least three axially spaced sealing portions 114. Although the present invention will be discussed in connection with seal 112 having three axially spaced sealing portions 114, including two end sealing portions 114a and a middle sealing portion 114b, any other number of axially spaced sealing portions 114 can be used. For example, seal 112 may include four axially spaced sealing portions, including two end sealing portions 114a and two middle sealing portions 114b. Seal 112 may be made of extruded rubber, for example, in a manner in which a length of rubber section is extruded, and then is cut to a predetermined length, followed by splicing the ends of the section together to form the cylindrical seal 112. Seal 112 may also be made of a resilient plastic material by an injection molding process, for example.

Each sealing portion 114 includes a plurality of sealing ridges 18 that are compressible against the internal surface 50 of a pipe to provide a fluid tight seal. Additionally, each sealing portion 114 further includes an annular expansion band seat 20, shown herein as an annular recessed area of sealing portions 114, for receiving an expansion band 30 of an expansion band assembly 26, as discussed below.

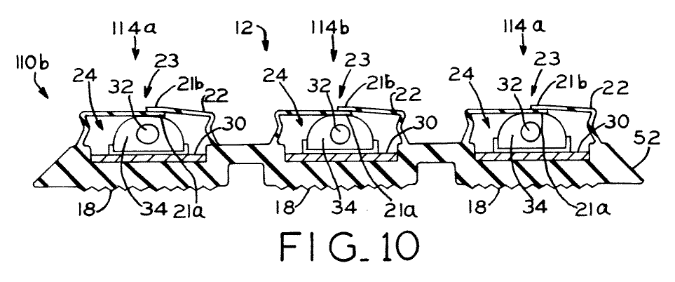

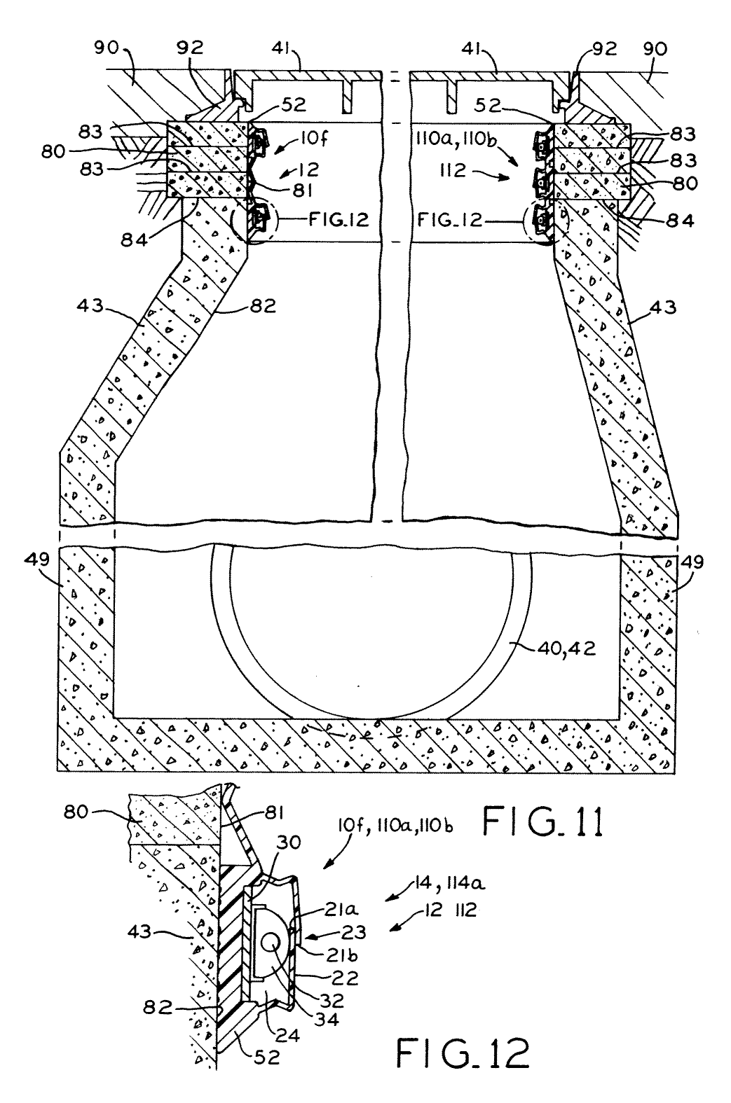

Additionally, as shown with respect to the embodiment of FIG. 10 and in the same manner as the embodiments described above, each sealing portion 114 may also be provided with a thin wall section 22 defining an annular hollow section 24 in the sealing portion 114 which accommodates the expansion band 30 and the expansion mechanism 28 of the expansion band assembly 26. As discussed below, the thin wall section 22 may include a small slit 23 for installation of the expansion band 30 and expansion mechanism 28 and for accessing the expansion mechanism 28 during and after installation for sealingly compressing the sealing portion 112 into fluid tight engagement with the interior surface of the pipe 50.

Seal assemblies 110a and 110b of FIGS. 6 and 10, respectively, may also include a ramp portion 52 at the outside ends of the two end sealing portions 114a to aid in directing a smooth or laminar flow of liquid within pipes 40 and 42 over and around the sealing assembly.

In use, seal assembly 110 may be used to seal a defective primary seal in a pipe-to-pipe connection between pipes 40 and 42, such as the connection between spigot end 44 of pipe 40 and socket end 46 of pipe 42 in which a primary seal 48, formed in an annular groove 49 of spigot end 44 of first pipe 40, is ineffective. Alternatively, seal assembly 110 may be used as a primary seal to seal pipes 40 and 42 upon initial connection and installation of pipes 40 and 42. Seal assembly 110 may also be used as a primary or secondary seal to seal a cracked portion within one of pipes 40 and 42.

When used to seal joints and cracks in pipes that are located underground, seal assembly 110 is capable of being folded in order to easily bring seal assembly 110 through a manhole or any other type of structure to its underground installation site, as shown in FIGS. 7-9. Referring now to FIG. 7, seal 112 of seal assembly 110 is shown in an unfolded substantially annular shape and includes a diameter D₁. The diameter D₁ of seal 112 can be as little as about 12 inches, 15 inches, or 18 inches, and as large as about 72 inches, 96 inches, or 120 inches. Seal 112 includes two end sealing portions 114a and one middle sealing portion 114b. Seal 112 further includes a first side portion 72 and a second side portion 74, disposed on substantially opposing sides of seal 112 along diameter D₁, which is perpendicular to a diameter connecting gap portions G₁ and G₂, discussed below.

In this embodiment, a pair of expansion bands 30 having ends 30a are received within expansion band seats 20 of end sealing portions 114a. Expansion mechanisms 28 are not initially installed to the seal assembly 110, but rather are installed later in the installation process, as discussed below. The area of sealing portions 114 and expansion band seats 20 that is disposed between expansion band ends 30a forms a gap portion G₁ oriented along an axis A₂, which is parallel to the central longitudinal axis of seal 112. Although not visible in FIG. 7, the opposite side of seal 112 also includes the above-mentioned features, including a corresponding second gap portion G₂. Gap portions G₁ and G₂ each form an area on seal 112 with lower resistance to folding due to the absence of expansion bands 30, thus allowing seal 112 to be folded as described below for fitting through relatively small openings or access points in underground pipelines, such as manholes.

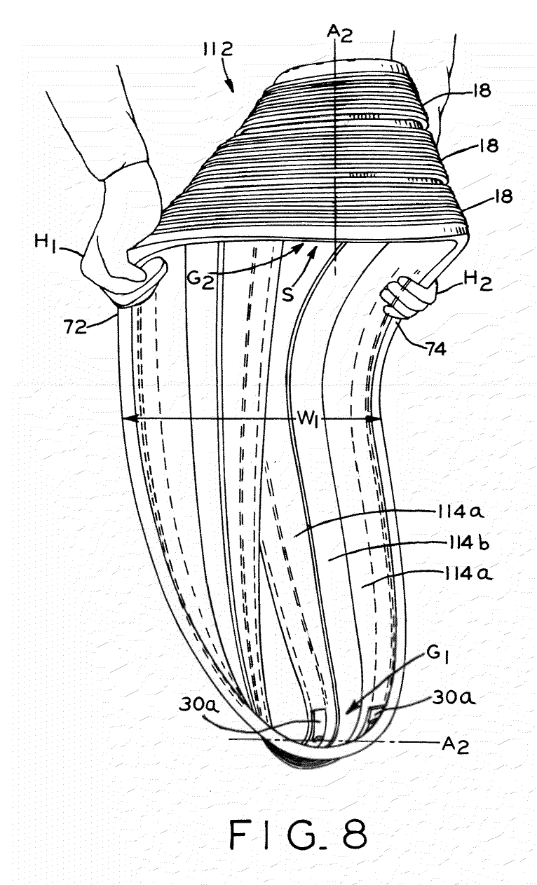

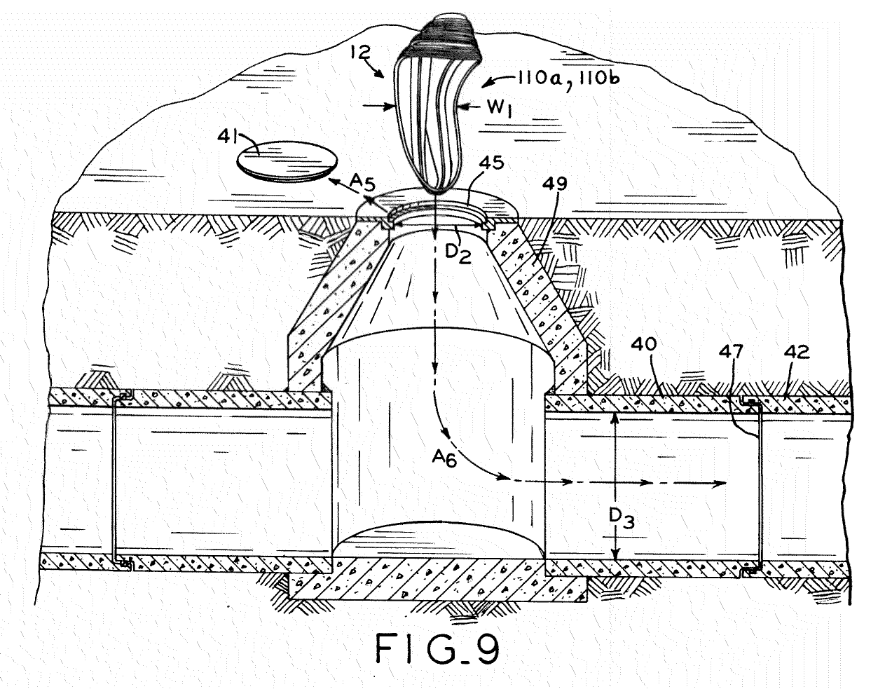

To begin the positioning and installation process, as shown in FIG. 7, a user grasps seal 112 at a first side portion 72 with a first hand H₁ and a second side portion 74 with a second hand H₂. The user then folds first side portion 72 and second side portion 74 of seal 112 toward each other in the directions of arrows A₃ and A₄, respectively, as shown in FIG. 8. This movement will allow gap portions G₁ and G₂ of seal 112 to be folded substantially about their axes A₂ As shown in FIG. 8, after folding, seal 112 will have an effective width or profile between first side portion 72 and second side portion 74, designated W₁ in FIGS. 8 and 9, that is less than its initial diameter D₁. As described above, first side portion 72 and second side portion 74, at which a user grips seal 112, do not have to directly oppose one another, so long as the user is able to fold seal 112 about gap portions G₁ and G₂ in the manner described above.

Referring now to FIG. 9, a method for installing seal assembly 110 in an underground pipeline is shown. First, the seal 112 of seal assembly 110, having diameter D₁, shown in FIG. 7, is provided. Next, seal 112 is folded to a width W₁, as described above and as shown in FIG. 8. Then, manhole cover 41 is removed from manhole opening 45, as shown by arrow A₅, to provide an opening having a diameter D₂ for seal assembly 110 to be brought to its underground installation site. The diameter D₂ of the manhole opening 45 can be as little as about 18 inches, 20 inches, or 24 inches, and as large as about 48 inches, 60 inches, or 72 inches. Diameter D₂ is larger than width W₁, but may be smaller than diameter D₁. Thus, seal 112 having a diameter D₁, if greater than diameter D₂, will not fit and pass through manhole opening 45 with diameter D₂, and it is necessary for seal 112 to be folded to a width W₁, as described above. Seal assembly 110 is then passed through manhole opening 45 and into the manhole riser 49 along arrow A₆. Once a crack (not shown), or a defective joint 47 between pipes 40 and 42 is located, seal assembly 110 is passed further along arrow A₆ to its installation site. The inner diameter D₃ of pipes 40 and 42 is roughly equal to diameter D₁ of seal 112. The diameter D₃ of pipes 40 and 42 can be as little as about 12 inches, 15 inches, or 18 inches, and as large as about 72 inches, 96 inches, or 120 inches.

Once seal assembly 110 is brought to its underground installation site, seal 112 is placed within the pipes 40 and 42 such that one end sealing portion 114a is positioned adjacent spigot end 44 of pipe 40 and the other end sealing portion 114a is positioned adjacent socket end 46 of pipe section 42. The third, middle sealing portion 114b is positioned with sealing ridges 18 substantially centered about and bridging joint line 47 formed by and between pipes 40 and 42. Alternatively, seal assembly 10 may be positioned such that the third, middle sealing portion 14b is positioned with sealing ridges 18 substantially centered about and bridging a crack formed in a single pipe.

Once seal assembly 110 is positioned at its underground installation site, the three expansion mechanisms 28 are positioned in expansion band seats 20 and connected to expansion band ends 30a, thus completing assembly of the expansion band assemblies 26. Expansion band assemblies 26 may be, for example, of the type disclosed in U.S. Pat. Nos. 6,805,359 and 7,146,689, each assigned to the assignee of the present invention, the disclosures of which are expressly incorporated herein by reference. Each expansion band assembly 26 generally includes an expansion mechanism 28 operable to expand the diameter of expansion band 30 of the expansion band assembly 26 radially outwardly to compress a sealing portion 114 against the inner surface 50 of pipes 40 and 42. In particular, as best shown in FIG. 5 and discussed in the above-incorporated U.S. Pat. Nos. 6,805,359 and 7,146,689, each expansion mechanism 28 generally includes a bolt 32 having oppositely-threaded ends and a central nut 33. The oppositely-threaded ends of bolt 32 are threadingly received within a pair of oppositely-threaded block members 34 which are in engagement with expansion band ends 30a. In use, nut 33 of bolt 32 is engaged by a suitable tool to rotate bolt 32 and drive block members 34 apart from one another to thereby expand the diameter of expansion band 30 to radially outwardly compress a sealing portion 114 of seal 10 into tight engagement with the inner surface of a pipe. Thereafter, expansion mechanisms 28 of expansion band assemblies 26 are actuated in the manner described above to outwardly radially compress sealing portions 114 and their sealing ridges 18 of seal 112 into fluid tight sealing engagement with the inner surfaces 50 of pipes, respectively, thereby providing a fluid tight seal between pipes 40 and 42 and joint line 47.

Each expansion band assembly 26 includes at least two semi-circular expansion bands 30, each having end portions 30a and at least two expansion mechanisms 28, while sealing assemblies 110 for larger diameter pipes may include three or more expansion bands 30 and three or more expansion mechanisms 28, as needed.

Referring to FIG. 10, in the embodiments in which sealing portions 114 include thin wall sections 22, one or more slits 23 may be formed, or may be cut in the field, in wall sections 22 which allow for expansion bands 30 and expansion mechanisms 28 of expansion band assembly 26 to be slidably inserted within annular hollow sections 24. The slit 23 may be disposed adjacent an expansion mechanism 28 to allow access to expansion mechanism 28 during or after installation to effect the seal as described above. Each slit 23 may extend around only a portion of the circumference of its wall section 22, such as around as little as 5°, 10°, or 15°, or as great as 30°, 60°, 90° or more, for example, of the circumference of wall sections 22, or alternatively, may extend around the entire circumference of wall sections 22.

The adjacent portions 21a and 21b of thin wall sections 22 defined by slits 23 may be disposed in tight abutting end-to-end contact with one another, similar to the embodiment shown in FIG. 2A, for example, or may overlap one another, as shown in the embodiment of FIG. 10, for example, in order to minimize or prevent fluid entry into hollow sections 24. Further, similar to the embodiment shown in FIG. 3, the slits 23 may be optionally disposed on a side of sealing portions 114 opposite a direction of fluid flow along arrow A₁, such as at location 23a, for example, to minimize or prevent fluid entry into hollow sections 24. Also, the expansion mechanisms 28 may be positioned at the upper end of the pipes 40 and 42 which are normally above the fluid level of the pipes to prevent or eliminate fluid entry into hollow sections 24.

When sealing assembly 110 is positioned across joint line 47 between pipes 40 and 42, middle sealing portion 114b of seal 112 may directly sealingly engage about and bridge joint line 47. Middle sealing portion 114b may also directly sealingly engage about and bridge a crack in pipes 40 and 42. Due to this positioning, middle sealing portion 114b applies pressure directly to, and about, the joint line 47. This is advantageous in that middle sealing portion 114b will therefore prevent water, or any other liquid, from leaking into and/or building up and forming a pressurized space between the outer surface of sealing assembly 110 and the inner surfaces 50 of pipes 40 and 42, thus preventing any potential for the shifting of end sealing portions 114a of sealing assembly 110 along the inner surfaces of pipes 40 and/or 42, or other movement or distortion of end sealing portions 114a of sealing assembly 110.

Referring now to FIG. 11, in another application the sealing assemblies described herein, such as sealing assemblies 10c, 110a, or 110b, may be installed in manhole riser 49 sealing a connection across joint lines 83, 84 formed between one or more grade rings 80 and/or manhole chimney 43 or manhole frame 92. Grade rings 80 are used to raise manhole frame 92 and its cover 41 to a position substantially flush with street surface 90. Sealing assembly 10c, 110a, or 110b may be prepared for installation and installed the same way as described above in the method for installing sealing assembly 110. However, in this instance, sealing assembly 10c, 110a, or 110b is brought to joint lines 83, 84 formed between grade rings 80 and manhole chimney 43, rather than to a crack or defective joint 47 between pipes 40 and 42. Once sealing assembly 110c, 110a, or 110b is brought to joint lines 83, 84 formed between grade rings 80 and manhole chimney 43, seal 12, 112 is positioned such that all joint lines 83, 84 between grade rings 80 and manhole chimney 43 and/or between grade ring 80 and manhole frame 92, are completely covered by seal assembly 10c, 110a, or 110b. This occurs when each end sealing portion 14, 114a is positioned adjacent grade rings 80 and manhole chimney 43. The remainder of the installation and the expansion of sealing assembly 10c, 110a, or 110b is performed as described above to provide a fluid tight seal across the inner surfaces 81 of grade rings 80 and the inner surface 82 of manhole chimney 43 and/or manhole frame 92, to prevent fluid infiltration into, or out of, manhole riser 49.

Although sealing assembly 10f, 110a, 110b are shown and described above, any other of the aforementioned sealing assemblies may be installed in manhole riser 49 to seal a connection across joint lines 83, 84 formed between grade rings 80 and manhole chimney 43. In an alternative embodiment, in cases where many grade rings 80 are utilized, sealing assembly 10c, 110a, 110b may be installed to seal a connection across joint lines 83 formed between each grade ring 80.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sealing assembly, comprising:
a cylindrical seal, comprising:
at least three axially-spaced annular sealing portions, each sealing portion including an expansion band seat; and
a plurality of expansion band assemblies, each expansion band assembly comprising:
an expansion band received within a respective said expansion band seat; said expansion band including a pair of end portions; and
an expansion mechanism, each said expansion mechanism including a drive mechanism, comprising:
a pair of block members each having a threaded bore therethrough, said block members removably engaged with respective end portions of said expansion band; and
a bolt including oppositely-threaded ends respectively threaded within said bores of said block members, wherein rotation of said bolt in a first direction causes said block members to be simultaneously driven apart from one another to thereby expand said expansion band.

2. The sealing assembly of claim 1, wherein said at least three axially-spaced, annular sealing portions comprise a pair of end sealing portions and at least one middle sealing portion.

3. The sealing assembly of claim 1, further comprising a wall section defining an annular hollow space proximate said expansion band seat.

4. The sealing assembly of claim 3, wherein each said wall section includes a slit, said slit defining a pair of end portions of said wall section.

5. The sealing assembly of claim 4, wherein said end portions are in tight abutting engagement with one another.

6. The sealing assembly of claim 4, wherein said end portions overlap one another.

7. The sealing assembly of claim 1, wherein at least one of said sealing portions is formed with a ramped portion adjacent said expansion band seat.

8. The sealing assembly of claim 1, wherein each of said at least three sealing portions further include a series of compressible, annular sealing ridges.

9. The sealing assembly of claim 4, in combination with a pair of pipes sealingly connected by said sealing assembly, wherein said slits are formed on portions of said wall sections that are disposed away from a direction of fluid flow through said pipes.

10. A method for installing a sealing assembly, said method comprising the steps of:
providing a sealing assembly, comprising:
a cylindrical seal having a first diameter, comprising at least one annular sealing portion, each sealing portion including an expansion band seat; and
at least a pair of expansion band segments each received within the expansion band seat, the expansion band segments each having a pair of end portions that respectively define a pair of gap portions between respective end portions of the expansion band segments,
folding the sealing assembly about the gap portions to a width less than the first diameter;
passing the sealing assembly into an underground structure having an opening with a second diameter, the second diameter being greater than the width and less than the first diameter; and
installing the sealing assembly.

11. The method of claim 10, wherein the cylindrical seal further comprises a wall section defining an annular hollow space proximate the expansion band seat, wherein each wall section includes a slit, the slit defining a pair of end portions of the wall section.

12. The method of claim 10, wherein said installing step further comprises installing the sealing assembly across a joint formed by two connecting pipes.

13. The method of claim 10, wherein said installing step further comprises installing the sealing assembly across a crack formed in a single pipe or plurality of pipes.

14. The method of claim 10, wherein said installing step further comprises installing the sealing assembly across a joint between a manhole chimney and at least one manhole grade ring.

15. The method of claim 10, further comprising the additional step of connecting a plurality of expansion mechanisms between respective pairs of the end portions of the plurality of expansion band segments.

16. The method of claim 15, further comprising the additional step of actuating the plurality of expansion mechanisms such that the plurality of expansion bands radially expand allowing the sealing assembly to engage with the inside surface of the pipes of the underground pipeline system.

17. The method of claim 10, wherein the plurality of expansion bands are at least partially covered by the cylindrical seal.

18. The method of claim 10, wherein the cylindrical seal comprises two annular sealing portions, and wherein said installing step further comprises installing expansion mechanisms into the gap portions.

19. The method of claim 18, further comprising the step of actuating the expansion mechanisms such that the expansion bands radially expand.

20. The method of claim 10, wherein the cylindrical seal comprises three annular sealing portions, including two end sealing portions and a middle sealing portion, and wherein said installing step further comprises installing expansion mechanisms into the gap portions.

21. The method of claim 20, further comprising the additional step of actuating the expansion mechanisms such that the expansion bands radially expand.
